(19) United States
(12) Patent Application Publication
(10) Pub. No.: US 2026/0197358 A1
(43) Pub. Date: Jul. 9, 2026

(54) REAL-TIME EMOTIONAL ENGAGEMENT IN ONLINE COMMUNICATION THROUGH CONTEXTUAL INTEGRATION

(71) Applicant: International Business Machines Corporation, Armonk, NY (US)

(72) Inventors: Yin Xia, Beijing (CN); Jun Su, Beijing (CN); Peng Hui Jiang, Beijing (CN); Guang Han Sui, Beijing (CN); Ying Cao, Beijing (CN)

(21) Appl. No.: 19/014,528

(22) Filed: Jan. 9, 2025

(51) Int. Cl. H04L 65/403; G06F 40/279; G06V 40/10; G10L 15/22; H04L 67/306

(52) U.S. Cl. CPC H04L 65/403; G06F 40/279; G06V 40/10; G10L 15/22; H04L 67/306

(57) ABSTRACT

Mechanisms are provided for presenting emotional feedback during real-time online communications. The mechanisms collect real-time online communication data of a participant computing device and executes first artificial intelligence (AI) computer model(s) on the collected real-time online communication data to extract key features indicative of an emotional state of a participant associated with the participant computing device. The mechanisms execute second AI computer model(s) to classify the extracted key features into an emotional feedback classification. The mechanisms map the emotional feedback classification to an emotional feedback element, in a library of emotional feedback elements, corresponding to the emotional feedback classification. The mechanisms modify a data stream, of the real-time online communication, associated with the participant computing device to include the emotional feedback element.

### BACKGROUND

The present application relates generally to a data processing apparatus and method and more specifically to a computing tool and computing tool operations/functionality for real-time emotional engagement in online communication through contextual integration.

Increasingly, collaboration between individuals is performed via online meeting or web conference software and services, their personal or work computing devices, and local or wide area data networks. Such technology allows individuals that are widely dispersed physically or geographically, or who otherwise cannot be physically present in the same room as other participants, to converse and interact with each other as if they were physically present in the same room. The software enables the streaming of both video and audio data, as well as the sharing of files, instant messaging capabilities, and the like.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided comprising collecting real-time online communication data of a participant computing device of a real-time online communication between a plurality of participant computing devices via one or more data networks. The method further comprises executing one or more first artificial intelligence (AI) computer models on the collected real-time online communication data to extract key features indicative of an emotional state of a participant associated with the participant computing device. The method also comprises executing one or more second AI computer models to classify the extracted key features into an emotional feedback classification of a plurality of predefined emotional feedback classifications. In addition, the method comprises mapping the emotional feedback classification to an emotional feedback element corresponding to the emotional feedback classification, from a plurality of possible emotional feedback elements in a library. Moreover, the method comprises modifying a data stream, of the real-time online communication, associated with the participant computing device to include the emotional feedback element.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram of components of a real-time emotional engagement through context integration engine for online communications in accordance with one illustrative embodiment; and

FIG. 3 is a flowchart outlining an example operation of a real-time emotional engagement through context integration engine in accordance with one illustrative embodiment.

### DETAILED DESCRIPTION

The illustrative embodiments provide an improved computing tool and improved computing tool operations/functionality for real-time emotional engagement in online communication through contextual integration. The illustrative embodiments provide advanced emotion recognition models to detect and interpret user expressions during real-time online communications and presenting to other participants in the real-time online communication an automated feedback representation that indicates an emotional response or state from the user. The feedback may be personalized to the user with different expression styles and patterns, as well as feedback modes, sensitivity, and other characteristics. The illustrative embodiments implement real-time data collection, computer vision/audio processing techniques, natural language processing, and continuous learning mechanisms which are configured specifically for emotional response detection and feedback generation during real-time online communications between the user and one or more other participants. These mechanisms solve issues, as discussed below, with existing real-time online communications by providing emotional feedback capabilities not currently present in these existing real-time online communications.

The rise of online communication platforms, such as online meeting and web conferencing platforms, has revolutionized the way we connect, learn, and engage with others remotely. Examples of such real-time online meeting/conferencing software via which real-time online communications may be performed include Zoom® (a trademark of Zoom Video Communications, Inc.), Microsoft Teams® (a trademark of Microsoft Corporation), Cisco Webex® (a trademark of Cisco Technology, Inc.), and the like. These examples are examples of multi-media based real-time communication platforms that provide both visual and audible real-time streaming content between participants of the online meeting or web conferencing platform.

Moreover, such online communication platforms may include single media communication capability handled over data networks. For example, a single voice-over-internet-protocol (VOIP) based audio communications where visual data is not presented and instead the communication is audible communication conducted over data networks. In some cases, the single media communication capability may be a textual communication, such as in the case of a real-time chat session with other participants via a textual conferencing platform. The illustrative embodiments described hereafter will focus on multi-media type online communication platforms comprising both visual and audible aspects, however the illustrative embodiments are not limited to such and the mechanisms of the illustrative embodiments may be applied to VOIP or other data based audio communications as well.

Despite their convenience, online communication platforms often fail to recreate the natural emotional dynamics present in face-to-face interactions. In traditional settings, speakers gauge audience reactions through non-verbal cues such as facial expressions, body language, and vocal responses. Similarly, the audience relies on these cues to express their emotions, provide feedback, or interact with the speaker directly.

Unfortunately, the current real-time online communication landscape predominantly offers limited options for emotional expression. Participants are typically restricted to using a predefined set of emojis (pictogram, logogram, ideogram, or the like embedded in text) or other text-based feedback, which can feel impersonal and detached from the actual emotions experienced. While selected by a user for inclusion in the real-time online communication, they are generalized and not personalized to the particular user. Moreover, the process of the user selecting and sending these digital elements from a listing of possible digital elements often introduces a delay, further diminishing the immediacy of emotional exchanges.

Thus, there is a need in real-time online communications, such as online meetings/conferences, to provide automated real-time emotional feedback to participants of the real-time online communication, where the emotional feedback provides elements of expressiveness and interactivity of emotional responses. By bridging the emotional gap between speakers and audience members in real-time online communications, the overall user experience can be significantly enhanced, fostering a more immersive and engaging online communication environment.

The illustrative embodiments provide a computing tool and computing tool operations/functionality to automatically express emotional responses of participants in a real-time online communication, such as a presentation by a user to one or more other participants. For example, during a presentation, one user may present information to one or more other participants, and the other participants may engage in an emotional response which is detected by the mechanisms of the illustrative embodiments, e.g., applause, admiration, disappointment, confusion, etc., and corresponding feedback may be presented to the user who is presenting the information, thereby enhancing user engagement and communication. The illustrative embodiments offer automated feedback generation based on real-time data analysis from image capturing devices, audio capturing devices, textual input capturing devices, and the like, e.g., webcams and microphones associated with user and participant computing devices. Advanced emotion recognition computer models of the illustrative embodiments detect and interpret user expressions, while contextual understanding of real-time online communication content ensures the relevance of the generated feedback.

The illustrative embodiments provide mechanisms for enabling user feedback personalization/customization through user-specific adaptation, aligning with individual expression styles and emotional patterns. Users are enabled with the flexibility to choose different feedback modes, adjusting the illustrative embodiments'sensitivity and response speed. As mentioned above, the computing tool and computing tool operations/functionality of the illustrative embodiments implement real-time data collection, computer vision/audio processing techniques and natural language processing for contextual analysis, and continuous learning for improved feedback accuracy.

The illustrative embodiments enhance real-time online communications through data networks and using participant computing devices by providing a more immersive and expressive environment, where users can effortlessly convey emotional responses, such as applause, admiration, disappointment, confusion, or the like, fostering a meeting atmosphere that is increasingly representative of a face-to-face interaction and promotes connection among participants. For purposes of the following description, the description will assume that a user is presenting content or information to an audience of participants, with participant emotions that are returned to the user being positive emotional responses such as applause or admiration. It should be appreciated that this is only an example and the illustrative embodiments may be implemented with, and provide other types of emotional response representations to users, which may be positive and/or negative.

The illustrative embodiments provide automated feedback and improved user engagement at least by generating real-time feedback, such as clapping hands or visual representations of admiration, based on user expressions of applause or admiration detected by real-time data collection and the artificial intelligence (AI) computer models analyzing this real-time collected data. The illustrative embodiments collect, in real-time, data from image capture and audio capture devices, e.g., webcams and microphones, which includes data representing facial expressions, body actions, audio cues, and the like, which are then fed into the AI computer models of the illustrative embodiments to perform detection and interpretation of user expressions. Based on the results of the AI computer model analysis of the real-time collected data, real-time emotional responses may be generated and output to the presenting user to express admiration, appreciation, or the like, through a virtualized graphical/audible expression, e.g., a graphical/audible expression representing applause or the like. This encourages active participation and creates a more interactive meeting experience both on the part of the presenting user and the other participants.

The illustrative embodiments further provide contextually relevant feedback at least in that the illustrative embodiments incorporate contextual analysis of real-time online communication, e.g., on-line meeting/conference, content to provide relevant and meaningful feedback aligned with the ongoing discussions. In general, feedback is considered “relevant”, “meaningful”, and “aligned” when it relates to the specific points being discussed at that moment, fits the tone and atmosphere of the meeting, and contributes to achieving the meeting's intended outcomes. The computing tool and computing tool operations/functionality of the illustrative embodiments determine relevant and meaningful feedback aligned with the discussion through one or more of contextual analysis of meeting content and user profiling, analyzing the tone and intent of the discussion, and linking to the goals and objectives of the meeting.

With regard to contextual analysis of the meeting content and user profiling, the illustrative embodiments analyze meeting topics and flow, and also examine the current discussion content and the audience's profile to gauge the relevance between the topics and the audience. For example, if the meeting is focused on a project update, and a participant makes a valuable contribution about a particular aspect of the project, the illustrative embodiments analyze the key points in that contribution and the overall context related to the project. Thus, if someone shares a new solution to a problem in the project, relevant feedback from the participant can be animated thumbs-up along with a text comment like “Great solution for the [specific problem] in our project!”, which shows that the person's contribution to the meeting is in line with what is being discussed.

With regard to analyzing the tone and intent of the discussion, the illustrative embodiments may analyze the tone of the conversation to categorize the tone into a plurality of different categories. For example, if the tone is a formal brainstorming session where people are presenting ideas in a professional manner, the feedback may match that formality and seriousness. On the other hand, if the tone is a more casual team catch-up with a lighter mood, the feedback can be more relaxed and friendly. For instance, in a formal brainstorming situation, relevant feedback for a well-thought-out idea might be a formal visual representation of approval like a virtual certificate or a message saying “Your idea is highly valuable for our current brainstorming on [topic].” In a casual setting, the feedback may be something like an animated smiley face with a comment like “That's a cool thought, [person's name]!”.

With regard to linking to the goals and objectives of the meeting, feedback is considered relevant and meaningful if it ties back to the overall goals or specific objectives of the meeting. Thus, if the meeting's goal is to finalize the marketing plan for a new product, and a user makes a comment that helps move that plan forward, like suggesting a new advertising channel, relevant feedback could be an image of a marketing award with a message like “Your suggestion is really helpful for our marketing plan for [product name].”

In order to perform such analysis and classification of these various aspects of the real-time online communication, existing technologies may be leveraged to extract relevant features or directly draw conclusions from different data or information. For example, in one illustrative embodiment, when judging whether a meeting is related to a specific topic or objective, firstly through text extraction in natural language processing technology, the conversation text in the meeting is extracted. Then, the illustrative embodiment uses word segmentation technology to break the text into individual words and phrases and further employs named entity recognition to identify key entities such as project names, product features, and specific tasks. At approximately the same time, the illustrative embodiment may utilize a predefined keyword database associated with various meeting topics or objectives, with which the content extracted from the conversation is compared. Once the matching keywords reach a certain percentage threshold, the illustrative embodiments may determine that the conversation is related to the corresponding topic or objective.

In another illustrative embodiment, the tone and intent of a conversation is determined and mapped to a feedback element using sentiment analysis algorithms in natural language processing to analyze the sentiment of each sentence or utterance in the conversation. The illustrative embodiment classifies the sentences/utterances as positive, negative, or neutral based on the words used, the context, and the overall structure of the language. For example, the statement “This idea is really brilliant!” is recognized as a very positive statement, whereas “This is confusing” is recognized as a negative statement. In addition to analyzing the text of the conversation, the illustrative embodiment also takes into account the facial expressions and body movements of the meeting participants. By using webcams to capture these visual cues, the illustrative embodiments can further ascertain the users'emotions. For example, a big smile and an energetic nodding of the head might indicate excitement and agreement, while a furrowed brow and crossed arms could suggest confusion or disagreement. By combining the sentiment, tone, and intent information, appropriate feedback is matched. For positive and excited emotion and feedback, an animated thumbs-up and an inspiring comment will be given. However, when the emotion is negative, and there is a questioning tone seeking clarification, the feedback element may be like an animation or comment expressing a question or inquiry.

In addition to the aspects above, the illustrative embodiments provide a feedback mode selection at least in that the illustrative embodiments enable users to choose different feedback modes (e.g., aggressive, moderate, or neutral) to adjust the illustrative embodiment's sensitivity and response speed, or by default the illustrative embodiments may automatically select the appropriate feedback mode based on the user's past habits. This functionality provides users with flexibility and control over the feedback generation process, further allowing users to customize the feedback generation to suit their communication style and communication objectives.

In some illustrative embodiments, the mechanisms provide a mapping of emotional responses to a virtual avatar that may be used to present emotional feedback to the presenting user. In such illustrative embodiments, a virtual/digital avatar, such as a three-dimensional rendering of a virtualized/digital person, may be generated as part of the real-time online communication (e.g., meeting). The avatar may be animated based on the detected user emotion, as detected by the AI computer models based on the real-time collected data from image/audio capture devices. The identified emotions and movements of the user detected by the AI computer models may be mapped to corresponding animations for the avatar so as to represent the particular participant's emotions in a manner perceivable by the presenting user.

As can be appreciated, each participant in the real-time online communication may have their own instances of the computing tool of the illustrative embodiments, such as an instance executing on the participant's own personal computing device, and each instance may be specifically configured for the particular participant. Moreover, each instance may be further personalized to the particular participant through user-specific adaptation and continuous learning mechanisms. That is, through user-specific adaptation, each instance of the illustrative embodiments is customized to generate that participant's emotional feedback to the presenting user in a manner that aligns with the individual participant's expression styles and emotional patterns. Moreover, the participant's emotional feedback may be personalized/customized to align with individual preferences and expression/communication styles.

Thus, for example, via the mechanisms of the illustrative embodiments, participants in a real-time online communication may automatically express emotional responses to presenter content/information, e.g., by providing emotional response elements representing applause or admiration. When a user attends a meeting and feels the need to applaud or show appreciation, the mechanisms of the illustrative embodiments detect their expression using real-time data from webcams and microphones, for example. By analyzing facial expressions and audio cues, the illustrative embodiments recognize the user's applause or admiration. The illustrative embodiments then generate automated feedback, such as displaying clapping hands or sending visual representations of flowers, to convey the user's positive response. Similarly, negative responses may be detected and corresponding emotional response elements automatically generated and added to the real-time online communication data stream for perceiving by one or more of the other participants.

Thus, the illustrative embodiments implement mechanisms that facilitate rich and timely emotional interactions in online virtual communication scenarios. By leveraging advancements in technology and user interface design, the illustrative embodiments empower participants with a broader range of expressive tools, allowing them to seamlessly convey their emotions and reactions in real-time. The illustrative embodiments create an online communication experience that closely mirrors the emotional dynamics of in-person interactions, fostering a stronger sense of connection and engagement among participants.

By providing automated feedback that reflects the user's emotional response, the mechanisms of the illustrative embodiments increase user engagement and active participation in real-time online communications, e.g., online meetings. Moreover, users feel more involved and connected to the content being presented, leading to a more attentive and interactive meeting experience. By combining the emotional state detection with effective contextual analysis of online content, the emotional feedback generation of the illustrative embodiments can be made more accurate to participant feedback intents. The accurate and automated positive feedback of applause or admiration, for example, contributes to a positive meeting atmosphere and encourages a supportive and appreciative environment, where participants feel acknowledged and valued for their contributions.

By automating the emotional state feedback generation, and thus, the expression of applause or admiration, the illustrative embodiments save time and effort for users. That is, the users no longer need to manually type comments or use external tools to convey their appreciation. This streamlines the communication process and allows for seamless and instantaneous feedback.

Through continuous learning and adaptation, the illustrative embodiments can personalize the generated feedback based on individual user preferences and emotional patterns. This customization enhances the user experience and ensures that the feedback aligns with each participant's unique expression style.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides real-time online communication augmentation to include virtualized representations of participant emotional feedback. The improved computing tool implements mechanism and functionality, such as a real-time emotional engagement through context integration engine which operates in conjunction with a real-time online communication platform, and which cannot be practically performed by human beings either outside of, or with the assistance of, a technical environment, such as a mental process or the like. The improved computing tool provides a practical application of the methodology at least in that the improved computing tool is able to augment and improve real-time online communications to include a virtualized representation of participant emotional responses as graphical/audible indicators or cues so that presenting users may be informed of how participants are responding to their presentation of content/information.

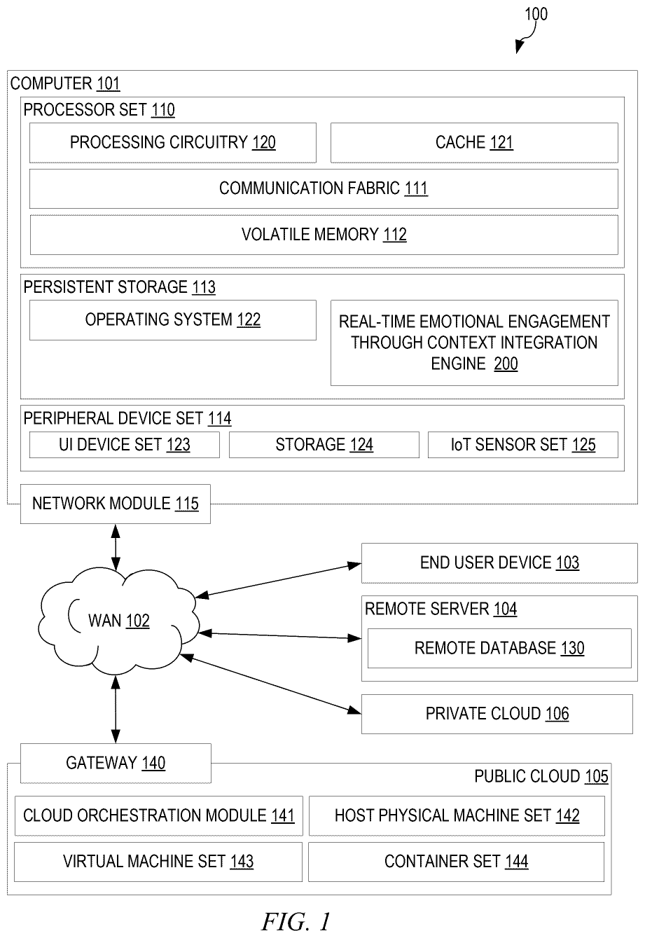

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as real-time emotional engagement through context integration engine 200 for online communications. In addition to real-time emotional engagement through context integration engine 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and real-time emotional engagement through context integration engine 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in real-time emotional engagement through context integration engine 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in real-time emotional engagement through context integration engine 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a real-time emotional engagement through context integration engine 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates virtual representations of emotional feedback to presenting users via real-time online communication platforms.

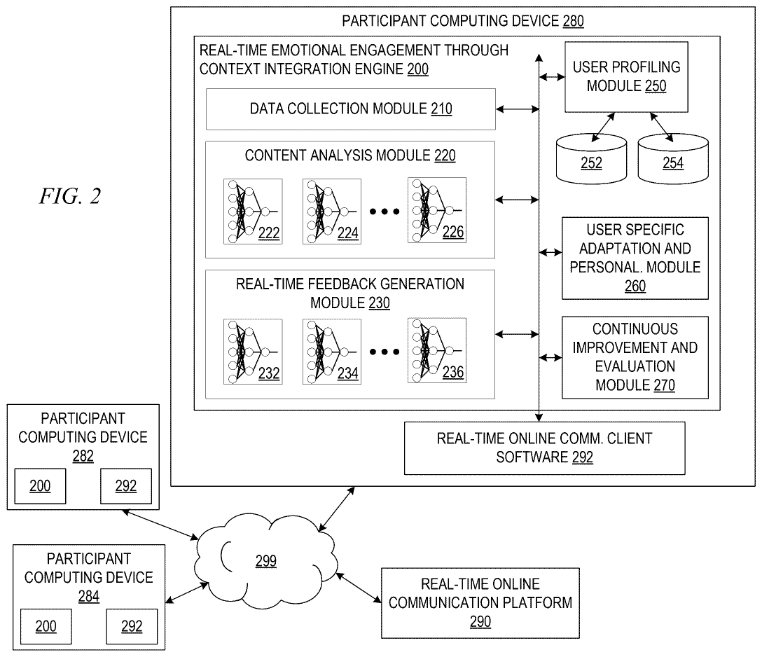

FIG. 2 is an example block diagram of components of a real-time emotional engagement through context integration engine for online communications in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that real-time online communications are performed, and providing a specific solution that implements real-time data collection, artificial intelligence (AI) computer model based detection and analysis of emotional responses from a participant based on the real-time collected data, and generation of emotional feedback virtual representations which are presented to a presenting user via the presenting user's computing device, which cannot be practically performed by human beings as a mental process and is not directed to organizing any human activity.

As shown in FIG. 2, the real-time emotional engagement through context integration engine 200 comprises a data collection module 210, a content analysis module 220, a real-time feedback generation module 230, a feedback mode control module 240, a user profiling module 250, a user-specific adaptation and personalization module 260, and a continuous improvement and evaluation module 270. All these modules work together in a coordinated manner. The data collection module 210 provides the initial data about user expressions. The content analysis module 220 supplies the context of the meeting. The real-time feedback generation module 230 uses this input to create feedback. The feedback mode control module 240 manages the style and frequency of that feedback. The user profiling module 250 and user-specific adaptation and personalization module 260 ensure personalization. The continuous improvement and evaluation module 270 keeps optimizing the whole process to make the system better at providing relevant and engaging feedback in online meetings.

In one or more illustrative embodiments, the data collection module 210 utilizes webcams, microphones, and the like to gather real-time data from users during online meetings. The data collection module 210 captures facial expressions, body actions, and audio cues. For example, the data collection module 210 can detect if a user is smiling, clapping hands, or speaking with an excited tone. This collected data is then passed on to other modules of the real-time emotional engagement through context integration engine 200. It serves as the foundation for the engine 200 to understand user expressions and emotions, enabling subsequent modules to make use of it to generate appropriate feedback. The data collection module 210 leverages technologies for detecting facial expressions, body movement, and other indicators of emotional responses, e.g., facial recognition technologies, emotion classification technologies based on deep learning, body movement analysis technologies, natural language processing, and the like. The conclusions of user emotions generated based on this data collection and subsequent analysis are used to determine what type of feedback should be mapped, such as positive, negative, or neutral feedback content.

In one or more illustrative embodiments, the content analysis module 220 focuses on analyzing the meeting content in real-time. The content analysis module 220 examines the text, topics, and the flow of the discussion happening in the meeting. By understanding the context, the content analysis module 220 can identify key points and the direction of the conversation. For instance, if the meeting is about a new product launch and people are discussing its features, the content analysis module 220 pinpoints these aspects and then shares this contextual information with the real-time feedback generation module 230 to help ensure that the feedback generated is relevant to the ongoing discussion and aligns with what is being talked about.

In some illustrative embodiments, in order to achieve real-time analysis of real-time online communication, e.g., meeting, content the content analysis module 220 may employ a combination of techniques and logic such as text extraction and tokenization, named entity recognition, topic modeling, conversation history analysis, and the like. With regard to text extraction and tokenization, the content analysis module 220 may start by extracting the text from the audio stream or any text-based input in the real-time online communication, e.g., the online meeting. This may be done using speech-to-text conversion technology if the input is spoken, which breaks down the spoken words into written text. Once the text is obtained, the content analysis module 220 may apply tokenization which splits the text into individual words and phrases, allowing for a more granular analysis. For example, in a sentence like “We need to focus on the new product's unique selling points”, the tokenization would break this sentence down into tokens like “We”, “need”, “to”, “focus”, “on”, “the”, “new”, “product's”, “unique”, “selling”, “points”.

With named entity recognition (NER), after tokenization, the content analysis module 220 utilizes NER to help identify key entities in the text. In the context of a meeting about a new product launch, the NER would recognize terms related to the product such as the product name, its features, target market, and any technical specifications. For instance, if the product is a smartphone, the NER would pick up words like “screen size”, “camera resolution”, “battery life” as important entities. Thus, the named entities determined to be important features may be dependent upon the particular topics of the real-time online communication.

To identify the underlying topics and the flow of the conversation, the content analysis module 220 employs topic modeling techniques, such as predefined keyword databases associated with various meeting topics or objectives. The content analysis module 220 analyzes the distribution of words across different segments of the text and groups them into topics. For example, if in one part of the meeting people are discussing the product's marketing strategy and using words like “advertising”, “target audience”, “social media promotion”, the content analysis module 220 would cluster these words together and identify a “marketing” topic. As the conversation progresses and switches to discussing the product's technical features, the content analysis module 220 would again group relevant words and identify a new “technical” topic, thus tracking the flow of the real-time online communication.

With regard to conversation history analysis, the content analysis module 220 stores the text, identified entities, and topics from previous segments of the real-time online communication. This history is used in multiple ways. For example, when new text comes in, the content analysis module 220 compares the current text and other information against the history to detect if there are any recurring themes or changes in direction. For example, if earlier in the real-time online communication there was a discussion about a problem with the product's design and now the text indicates a proposed solution, the content analysis module 220 can link the two and understand the progression. The history also helps in providing context for newly introduced topics. If a new feature is suddenly mentioned, the content analysis module 220 can look back at the history to see if there was any related precursor discussion.

Thus, through a combination of text extraction, NER, topic modeling, storage and analysis of real-time online communication history, all of which may also be integrated with large language models (LLMs), the content analysis module 220 is able to analyze the real-time online communication content in real-time, identify key points, and track the flow of the communication to ensure relevant feedback generation. Regarding the use of a large language model (LLM), the LLM can be used by the content analysis module 220 in a number of different ways to implement aspects of the illustrative embodiments. In some illustrative embodiments, an LLM may be utilized to enhance the understanding of the real-time online communication context. An LLM, with its vast knowledge base, can also provide additional background information related to the topics being discussed. The LLM can also be used in generating more intelligent and contextually relevant feedback.

Based on the data received from the data collection module 210 regarding user expressions (like applause or admiration signs) and the context information provided by the content analysis module 220, the real-time feedback generation module 230 generates real-time feedback. The real-time feedback generation module 230 may create visual representations like animated clapping hands, thumbs-up icons, or text messages that show admiration. For example, if a user shows excitement through facial expressions while a valuable point is being made in the meeting, the real-time feedback generation module 230 quickly generates feedback like an animated celebration graphic along with a positive comment to enhance user engagement and respond to the user's emotional state.

The real-time feedback generation module 230 may utilize a mapping to map particular emotion classifications to particular classifications of emotional feedback elements used to generated the real-time feedback, e.g., particular types of animations, graphics, audible outputs, and the like. That is, the real-time feedback generation module 230 may process the key features of emotional state or response by participants, as recognized by the data collection module 210 and content analysis module 220, via one or more rules-based or machine learning based computer models which classify the input of the key features into one of a plurality of possible emotional states/responses. This generates an emotional state/response label which may then be used to compare to similar emotional state/response labels of predefined emotion feedback elements. The labels for such emotion state/response labels may be predefined through a manual classification process, e.g., different animations, pictures, audible outputs, or the like, may be manually tagged with different labels for subsequent use.

In other illustrative embodiments, various animations, pictures, audible outputs, and the like may be automatically classified and labeled. By leveraging color theory and image element recognition, for example, positive feedback often employs bright and warm colors and elements like smiling faces or thumbs up, negative feedback uses dull and cold colors and elements such as crying faces or broken hearts, and neutral feedback features plain and soft colors and simple, unemotional elements. The rhythm of animations also varies among the three modes, with positive ones being brisk, negative ones being slow and heavy, and neutral ones being steady. Moreover, in still other illustrative embodiments, such feedback elements may be labeled using machine learning or semantic analysis. For machine learning, a large number of annotated samples are collected and used to train models. The trained model can then classify or label new images or animations. For semantic analysis, an emotional dictionary is used to match words in the text feedback, and syntactic and semantic rules are considered to determine the overall sentiment, classifying the feedback as positive, negative or neutral accordingly.

Thus, a library, database, or mapping data structure is generated that comprises various animations, images, audible outputs, and/or the like, for use in providing an emotion feedback element during real-time online communications. The matching of labels between the current emotional state/response feedback of the real-time online communication for a participant and the labels of these emotion feedback elements may then be used to determine an emotion feedback element to be presented as part of the real-time online communication.

The feedback mode control module 240 allows users to choose between different feedback modes such as aggressive, moderate, or neutral, as discussed further hereafter. The feedback mode control module 240 either responds to user selections or automatically selects an appropriate mode based on the user's past habits. When users want a more enthusiastic response (aggressive mode), the feedback mode control module 240 adjusts the system sensitivity to user expressions so that feedback is generated more frequently and with more vivid animations. In a moderate mode, the feedback is more balanced. The feedback mode control module 240 works with the real-time feedback generation module 230 to control the style and frequency of the feedback based on the chosen mode, giving users flexibility over the feedback generation process.

The user profiling module 250 operates to build profiles for each user by collecting and analyzing data about their past behaviors, communication styles, preferences, and typical emotional expressions in meetings over time. For example, the user profiling module 250 may note that a particular user often gives positive feedback in a more reserved way or prefers simple visual cues instead of elaborate animations. This information is then shared with the user-specific adaptation and personalization module 260 to help customize the feedback according to the individual user's characteristics. The user profiling module 250 may leverage existing technologies for user profiling and determining user preferences. However, the user profiling module 250 of the illustrative embodiments also adjusts the existing user preferences based on the user's feedback or modifications to the feedback operations. For example, users can be asked to rate the system's feedback operations, or if the user makes modifications or adjustments after the feedback suggestions are generated, the existing user preferences can be modified according to the situation. The purpose of knowing the user's preferences is to allow the system to make subtle adjustments based on the user's characteristics when selecting feedback content to better suit the user's characteristics.

The user-specific adaptation and personalization module 260 uses the user profiles from the user profiling module 250 to customize the generated feedback. The user-specific adaptation and personalization module 260 adapts the type, style, and content of the feedback to match an individual user's expression styles and emotional patterns. For instance, if a user is known to use humorous feedback, the user-specific adaptation and personalization module 260 may generate more light-hearted and funny comments or animations for that user. The user-specific adaptation and personalization module 260 works closely with the real-time feedback generation module 230 to ensure that the feedback is personalized to align with each user's preferences and communication styles.

Thus, through the user profiling module 250, the user-specific adaptation and personalization module 260 obtains details on user preferences and/or expression styles (humorous, formal, etc.). The feedback mode control module 240 determines a set of applicable feedback content (which may include animations, pictures or comments, etc.) based on the user's facial expressions, body movements, voice, and the like. The user-specific adaptation and personalization module 260 selects the feedback content that is closest to the required user preferences or expression styles from the those available in the library, database, or mapping data structure, based on the obtained user preferences or expression styles, as well as the labels or classification information of these feedback contents. For example, if a user likes simplicity, the user-specific adaptation and personalization module 260 finds a simpler icon like a small thumbs-up. It is also possible to modify the default comment associated with the feedback according to the required style or preference through a large language model (LLM), such as if a user is humorous and the initial feedback is “Good idea”, it looks for funnier alternatives such as “That's a cracking idea, mate!”.

The continuous improvement and evaluation module 270 monitors and evaluates the effectiveness of the feedback generated by the engine 200. The continuous improvement and evaluation module 270 looks at factors, such as how users respond to the feedback (do they engage more actively, or does it seem ignored), whether the feedback is truly relevant and appropriate in different meeting contexts, and if the chosen feedback modes are working well for users. Based on this evaluation, the continuous improvement and evaluation module 270 can provide insights and suggestions to other modules of the engine 200. For example, the continuous improvement and evaluation module 270 may recommend to the feedback mode control module 240 to adjust the default mode for a certain user if the continuous improvement and evaluation module 270 finds that the current setting is not resulting in good user engagement. It also helps in improving the overall performance and accuracy of the engine 200 over time by learning from past experiences and making necessary adjustments through a reinforcement learning processing given these evaluations as feedback. As new real-time online communications, e.g., meetings, occur and more data becomes available, the process loops back to data collection. The model is then updated and refined, continuously learning and adapting to improve the overall performance and accuracy of the engine. In this way, by leveraging the continuous improvement and evaluation module 270, the system or model is able to “learn” and enhance its capabilities over time.

To explain the modules in more detail, the content analysis module 220 may comprise one or more artificial intelligence (AI) computer models 222-226 that operate to perform various types of processing on the data collected by the data collection module 210 to thereby extract key features indicative of emotional state and feedback intent by a participant to the real-time online communication hosted by the real-time online communication platform 290. The real-time feedback generation module 230 may further comprise one or more AI computer models 232-234 that determine an emotional state classification and feedback intent of a participant and map the pairing of emotional state classification and feedback intent to one or more predefined emotional feedback elements for representing the emotional feedback of the participant to one or more other participants in the real-time online communication. The user profiling module 250 may further comprise a user profile 252 and a historical communication data structure 254 which together store the user (participant) personal information, settings, and preferences, as well as historical data for previous and current real-time online communications which can be used to determine and customize emotional feedback provided to other participants.

The computing devices 280-284 comprise real-time online communication client software 292 which provides the computer logic for conducing real-time online communications, e.g., web meetings/conferences, over one or more data networks 299. The client software 292 may communicate data with the real-time online communication platform 290 and provides real-time meeting/conference capabilities by streaming data between the participant computing devices 280-284 of an online meeting/conference session, via the one or more data networks 299 connecting these participant computing devices 280-284. Real-time online meeting/conferencing software and services are generally known in the art and thus, a more detailed explanation of how they operate is not provided herein. Examples of such real-time online meeting/conferencing software may include Zoom® (a trademark of Zoom Video Communications, Inc.), Microsoft Teams® (a trademark of Microsoft Corporation), Cisco Webex® (a trademark of Cisco Technology, Inc.), and the like. The real-time emotional engagement through contextual integration engine 200 operates in conjunction with this real-time on-line communication platform 290 to conduct real-time online communications, e.g., online meetings/conferences, and provide the enhanced and extended capabilities of the illustrative embodiments to improve the operation of such real-time online communications with regard to providing automatically identified emotional response feedback representations to participants.

The participant computing devices 280-284 may be of various types, e.g., laptops, desktop computer, mobile smartphones, tablet computers, personal digital assistant devices, and the like, and may be of different makes and models. For example, some participants to a real-time online meeting via real-time online communication platform 290 may be participating from mobile smartphones, others may be participating from desktop computers, and still others may be participating from tablet computers. Each of these various devices may be configured, such as when installing the client software 292 on these devices 280-284, to implement the real-time emotional engagement through context integration engine 200. For example, real-time emotional engagement through context integration engine 200 may be a sub-component of the real-time online communication platform 290 and may be a functionality accessed by, or implemented on, the computing devices 280-284 via the client software 292.

The user profiling module 250 has an associated user profile 252 data structure which stores the user profile for the user of the participant computing device 280-284. This user profile 252 data structure may specify preferences that are to be used with each real-time online communication, one-time preferences, or the like, along with any other suitable user specific information for configuring the participant computing device 280-284 for use with real-time online communication platform 290, e.g., login information, display name information, preferences regarding camera enablement, microphone enablement, screen text sizes, etc. In accordance with the illustrative embodiments, one preference that may be specified in the user profile 252 is whether or not to enable automated emotional feedback generation by the real-time emotional engagement through context integration engine 200 when the participant computing device 280-284 is operating as a participant during the real-time online communication conducted via the real-time online communication platform 290. This may be set as a default setting in the user's profile 252 and may be overridden on a case-by-case basis by the user for particular real-time online communications, such as when the user joins the meeting/conference and selects a setting to override this default setting, e.g., enabling/disabling the automated emotional feedback generation. This setting or override of the setting may be used to enable/disable the functionality of the real-time emotional engagement through context integration engine 200.

Thus, when a participant computing device 280-284 joins an online meeting or conference via their client software 292 and the real-time online communication platform 290, the participant can select an automated emotional feedback generation mode of operation and/or this setting may be retrieved from the user profile 252 specifying online meeting/conference preferences. As a result, the functionality of the real-time emotional engagement through context integration engine 200 may then be enabled/disabled for this particular user as a participant to the real-time online communication. For purposes of the following discussion, it will be assumed that such functionality is enabled by the user via their user profile 252 and is not overridden.

As can be appreciated, while only shown in detail in with regard to one participant computing device 280 in FIG. 2 for convenience, each participant computing device 280-284 participating in the real-time online communication may have their own instances of the real-time emotional engagement through context integration engine 200. Each instance may be specifically configured for the particular participant associated with the participant computing device 280-284. Moreover, each instance may be further personalized to the particular participant through user-specific adaptation and continuous learning mechanisms, as discussed hereafter. That is, through user-specific adaptation, each instance of the illustrative embodiments is customized to generate that participant's emotional feedback to the presenting user and/or other participants, in a manner that aligns with the individual participant's expression styles and emotional patterns. Moreover, the participant's emotional feedback may be personalized/customized to align with individual preferences and expression/communication styles.

With the mechanisms of the illustrative embodiments, assume that a user is part of a real-time online communication being conducted via client software 292 on a client computing device 280 which communicates and interacts with a real-time online communication platform 290, such as may be hosted by one or more servers of an organization. The user will log-into the real-time online communication platform 290 via their client computing device 280 and client software 292 for the real-time online communication platform 290, and join the real-time online communication along with one or more other participants via their corresponding client computing devices 280. The client computing devices 280-284 are preferably equipped with audio/video/text capture devices, such as digital cameras, microphones, keyboard interfaces, and the like (not shown), through which the client computing devices 280-284 may capture images/audio associated with users of the client computing devices 280-284, e.g., participants of the real-time online communication, and stream that real-time captured data to other participant's computing devices 280 via one or more data networks 299.

It should be appreciated that individual participants can enable/disable the streaming or presentation of one or more of the images/audio to the other participants as desired, such as for privacy reasons or the like. This may effectively “black-out” or replace their video feed with a still image. Moreover, similar obscuring of audio input from participants may also be performed, such as by silencing a microphone or the like. This may not disable the actual capturing device from capturing the data, but may disable the transmission of such data to other participants. Thus, data collection via these devices may still be made possible for emotional state classification and mapping to emotional response elements, as discussed hereafter.

Thus, in some cases, participants may be able to view/hear the video/audio output of other participant computing devices, but may have their own video/audio output blocked, and the same is true of the other participants as well. Thus, for these participants whose video/audio is blocked, it may not be possible for other participants to discern their emotional responses to the content/information being presented or shared during the real-time online communication, as one cannot see/hear their video/audio. In such instances, the illustrative embodiments are able to provide participant emotional feedback elements to represent the emotional responses of participants even when their video/audio transmission is disabled.

While the illustrative embodiments are not limited to instances where video/audio is blocked, this is one instance where the mechanisms of the illustrative embodiments can provide significant benefits as will be apparent from the present description. Whether video/audio is blocked or not, the illustrative embodiments may augment the presentation of emotional feedback during the real-time online communication via the platform 290 so that a presenting user and/or the other participants, can be presented with graphical/audible feedback via their computing devices 280-284 to inform them of the emotional response of a given participant.

That is, during the real-time online communication, participants will make facial expressions, perform movements, and may utter responses, vocal cues, and the like at their client computing devices 280-284 which may be captured by the local image/audio capture devices of the client computing device 280-284. The data collection module 210 of the client computing device 280 may be configured with pre-processing logic to analyze and extract relevant features from the collected data. This collected data may not only be used during real-time generation of emotional feedback, but may also be used by the user profiling module 250 to develop a user profile 252 and historical communication data structure 254 by identifying reactions to different content that represent individual preferences, interests, and emotional patterns. The user profiling module 250 may operate both on the collected data and/or on the features extracted from this collected data by the content analysis module 220, as well as results of the real-time feedback generation module 230 to generate this user profile 252 and/or historical communication data structure 254.

The captured data from the data collection module 210 may be processed through a content analysis module 220 comprising a plurality of artificial intelligence (AI) computer models 222-226, e.g., neural networks, deep learning neural networks, computer natural language processing (NLP) models, language models (LMs), large language models (LLMs), and the like. The data may be processed via speech-to-text conversion algorithms to convert audio speech signal data into textual forms, computer natural language processing (NLP), image/computer vision analysis, facial expression recognition, and other known, or later developed, AI content analysis techniques to analyze the data captured by image/audio/text capturing devices in the physical location of a participant. While the illustrative embodiments may leverage existing technologies for fundamental audio and video analysis and feature extraction, the illustrative embodiments further comprise computing logic to integrate these cues with the contextual analysis of the meeting content. For example, illustrative embodiments do not just detect that a user is smiling or speaking loudly, but also relates these expressions to the specific topic being discussed at that moment in the meeting.

For example, in some illustrative embodiments, to get user data, the data collection module 210 gets data from cameras and microphones around the user. For audio, the data collection module 210 changes speech to text so that NLP may be used on the textual representation of the audio. For visuals, like picture and video data, the data collection module 210 uses image analysis techniques to extract image features. Then the topic or progress of the meeting is determined by using a combination of text extraction, NER, topic modeling, and analysis of conversation history, etc. Thus, when a user smiles and nods and the text has good words about the “marketing” topic, the computer links them to determine that the user is expressing a positive emotion about the topic “marketing”. The illustrative embodiments stores history records and performs analysis that gives weights based on how often these correlations have happened during the real-time online communication. Thus, if users often smile when talking about good marketing, it gives that correlation a high weight. In this way, the illustrative embodiments tie expressions to topics.

Thus, for example, if in a meeting about a new marketing strategy, a user shows excitement through facial expressions when a particular advertising idea is mentioned, the engine 200 combines the visual cue with the understanding of the marketing context to generate feedback, such as “Your enthusiasm for the [specific advertising idea] is really inspiring for our marketing strategy”, or an emotional expression graphic/animation. Whether to use a statement and/or emotional graphic/animation, or a combination of both, may be determined based on user preferences or style as specified in a corresponding user profile as noted previously.

The AI content analysis techniques implemented by the AI computer models 222-226 may further incorporate contextual understanding by considering the ongoing discussion, previous interactions, and topic relevance. For example, LMs/LLMs may be used in which the prompts to the LMs/LLMs may comprise the context of the on-going textual transcript of the conversation generated by the speech-to-text and NLP capabilities of the AI computer models 222-226. This information may be analyzed by the LMs/LLMs to identify key terms/phrases, topics, and the like, and these identified elements of the on-going discussion may be provided as further input and a basis for analyzing the current inputs to the real-time online communication. Thus, for example, given the context of the discussion, a participants'verbal response may be able to be categorized into one of a plurality of emotional response categories and the corresponding discussion topics, key terms/phrases, or the like may be considered emotional triggers and particular sentiment pattern for the particular participant.

Based on the content analysis and contextual understanding results identifying key emotional triggers and sentiment patterns in real-time collected data from a participant, AI computer models 232-234 of the real-time feedback generation module 230 are used to perform sentiment analysis and emotion recognition on the real-time collected data associated with the emotional triggers to thereby determine the participants'current emotional state and their feedback intent. The illustrative embodiments may leverage known emotion analysis and recognition technologies; however, the illustrative embodiments provide additional computer logic to analyze the relevance between the user's emotional responses and the meeting discussion topics. For example, when a detected emotion of excitement is identified, the engine 200 does not just register it as a general positive emotion, but instead delves deeper to understand if that excitement is related to a particular point being debated in the meeting, such as a proposed solution to a problem or a new idea. This way, the feedback generated based on the emotion can be more contextually appropriate and meaningful, rather than a generic response that might not tie in with the specific meeting discussion.

For example, one or more AI computer models 232-234 may be trained through machine learning training processes to recognize patterns in image data, audio data, textual input data, or any combination of inputs, that correspond to different emotional state classifications, e.g., happy, sad, confused, appreciation, disappointment, etc. There may be a single AI computer model 232 trained for this purpose and which may output a vector with values in vector slots corresponding to different emotional state classifications with the values representing a probability that the input data corresponds to that slot's particular emotional state classification. There may be separate AI computer models 232-234 trained for different ones of the emotional state classifications, in which case the input may be provided to each of these AI computer models which would then output an output indicating a probability that the emotional state classification applies to the input.

In training these AI computer models 232-234, and following a similar approach for the other AI computer models 222-226 of the content analysis module 220, the machine learning training process uses training data comprising patterns of image/video/audio/text data, contextual data, and any other input data that the AI computer model 232-234 is configured to receive, and upon which the AI computer model 232-234 is to operate to generate an output. The training data samples will each also have a corresponding ground truth label specifying the emotional state classification for that input data. The AI computer model 232-234 is trained by having it process the input data to generate a result, and having that result compared to the ground truth label to determine an error or loss. A machine learning training algorithm is then applied to that error or loss to adjust the operational parameters of the AI computer model 232-234 so as to reduce the error or loss in the next iteration, e.g., a linear regression algorithm may operate to perform linear regression on the error or loss and determine a new set of operational parameters predicted to reduce that error or loss. This process repeats until a convergence criterion is reached, e.g., the error/loss is equal to or below a given threshold error/loss or a predetermined number of iterations of machine learning training have occurred, or the like. Once trained, the AI computer model 232-234 may be tested and, assuming that satisfactory performance metrics are obtained from the testing, may be deployed for runtime operation on new input data.

This AI computer model analysis may further determine feedback intent from such inputs as well. The emotional state classification provides an indicator of the emotion of the participant. The feedback intent provides an indicator of the type of feedback the participant intends to provide to a presenting user in response to the content being presented by the presenting user, e.g., applause, thumbs up, jeering, etc. Thus, the AI computer model(s) 232-234 generate an emotional state classification based on the real-time captured data from the image/audio/text capture devices associated with a participant's client computing device, e.g., webcams, microphones, keyboard, etc. The AI computer model(s) 232-234 may further determine feedback intent in a similar manner.

Emotional state refers to the actual emotional condition that a user is experiencing during the online meeting, e.g., happiness, excitement, frustration, confusion, or any other emotion that is manifested through their facial expressions, body language, tone of voice, and other cues. For example, a user might show a big smile and an energetic tone, indicating a state of excitement or joy. These emotional states are internal feelings that become visible and are picked up by the engine's data collection mechanisms. In contrast, feedback intent is centered around analyzing the correlation between the user's emotions or expressions and the discussion topic. It aims to decipher what kind of feedback the user might want to convey to the speaker or other attendees. For example, if a user appears excited and nods vigorously when a particular solution to a problem is being discussed, the system analyzes this emotional and physical expression in relation to the topic. The feedback intent could then be to affirm the value of the proposed solution and encourage further exploration. This may result in the engine 200 generating feedback like an approving icon and a comment such as “Your enthusiasm for this solution seems to indicate its potential. Let's dig deeper.” The feedback content may be modified based on user preferences and style as specified in user profiles. Based on the predefined feedback content (including animations, pictures, text, sounds and other materials), the content is adjusted and modified with the help of a general large language model (LLM). The context information and prompts provided to the large language model may include one or several selected predefined feedback contents, as well as modification targets based on user preferences and style. The intent of the resulting generated feedback is to enhance the interaction and progress of the meeting by understanding the user's emotional response within the context of the discussion topic and facilitating the communication of relevant feedback among the participants.

The real-time feedback generation module 230 maps the user's emotional state classification and feedback intent to an appropriate emotional response element, such as an emotional expression graphic, symbol, animation, emoticon, or other visual/audible element available from a predetermined library 236 of such emotional response elements. For example, if a user's emotional state classification is appreciation, and their feedback intent is classified as a physical movement, then this pairing of emotional state classification and feedback intent may be mapped to an animation of hands clapping from a library of emotional response elements. If a user's emotional state classification is disappointment and their feedback intent is a physical movement, then this pairing may be mapped to a graphic of a sad face, a shaking head animation, or the like.

The emotional response element may then be used by the logic of the real-time emotional engagement through context integration engine 200 to augment or otherwise modify the data stream of the real-time online communication facilitated vi the real-time online communication platform 290 between the participant computing devices 280-284 so that the emotional response element is made perceivable to one or more of the other participants via their client software 292 instances and the graphical user interfaces rendered by this client software 292 on the corresponding participant computing device 280-284. For example, in some illustrative embodiment, the emotional response element may be superimposed on a portion of a graphical user interface (GUI) of a presenter participant computing device 284 to indicate to the presenter the emotional feedback from the other participant computing device 280.

This may be done in a way that does not specifically identify the particular participant providing the emotional response, e.g., in a general field of the GUI, in a predetermined area of the GUI display, or the like. In other illustrative embodiments, the emotional response element may be presented in association with a portion of the GUI display associated with the particular participant providing the emotional response, e.g., in the window or portion of the screen allotted to that particular participant. In some illustrative embodiments, the emotional response element may be presented to all or a sub-portion of the participant computing devices 280-284 of the real-time online communication, as may be designated by configuration parameters, settings, pull down menu selections by the participant, user profile settings, or the like.

In some illustrative embodiments, the emotional response elements are used to augment or modify the data stream automatically in response to detecting the participant's emotional state and feedback intent. In other illustrative embodiments, the identification of emotional response elements may be used to present to the participant a suggested emotional feedback that the presenter may then selected to send to the one or more other participants, the presenter participant, or the like. Thus, the participant may be presented with a GUI through which the participant may select an emotional response element from a set of one or more emotional response elements considered to be relevant to the participant's current emotional state classification, and the participant may select an appropriate one and to whom they wish to send this emotional response element.

At the other participant computing devices, e.g., 282-284, the displayed GUI of the real-time online communication platform 290 is modified to include the emotional response element for those participants selected to receive such by the participant providing the emotional response element, e.g., the participant associated with participant computing device 280. Thus, for example, if the participant is sending an emotional response element of an animation showing applauding hands, these may be superimposed on the other elements of the GUI at the presenter computing device so that they may see the applauding hands animation and know that their presentation content is being appreciated by one or more of the participants, and in some cases the particular participant providing the applause animation.

In some illustrative embodiments, this emotional response element may be an animated avatar associated with a particular participant. The avatar is a virtual representation of the participant, which may or may not resemble that participant, may be fanciful in nature, or the like. The avatar's presentation may be modified based on the determination of the emotional state classification and feedback intent by causing the representation of the avatar to implement the emotional response element. For example, the avatar may be controlled to perform an applause action in response to a determination that the emotional response element should be an applauding animation. Other modifications to the avatar may include graphical representations of facial expressions, movements, gestures, and the like, which are mapped to the emotional state classification and feedback intent of the participant.

In some illustrative embodiments, the participants are provided with additional customization capabilities to specify different feedback modes that they wish to enable for providing emotional response element feedback. For example, through a feedback mode control module 240, a participant may select an aggressive, moderate, or neutral mode of feedback generation, and have this selection set in their user profile 252. When selecting the aggressive mode, the emotional state and feedback intent recognition is more sensitive and the generated feedback, i.e., emotional state element generation and presentation, is faster and more agile in response to the participant's detected expressions. In a moderate mode of operation, a higher threshold for emotional state and feedback intent recognition is set which results in more cautious and careful feedback generation. In a neutral mode of operation, an intermediate setting is enabled between the aggressive and moderate modes of operation, thereby providing a balanced approach to feedback generation.

In some illustrative embodiments, the particular feedback generation mode may be automatically set by the feedback mode control module 240 based on a detection of the user's previous past habits, i.e., an analysis of the stored historical communication data structure 254. For example, over time, the user may have a pattern of selecting aggressive, moderate, or neutral feedback generation modes for different real-time online communications with particular types of participants and these selections may be logged in the historical communication data structure 254. For example, the participant may use an aggressive mode of operation when conducting real-time online communications with same level co-workers, a moderate mode when conducting such communications with their boss or higher level workers in an organization, and neutral mode of operation when communicating with family and friends. The same patterns may be associated with other types of characteristics of real-time online communications, such as topics discussed, time of day (work hours, after hours, etc.), and the like. Such historical patterns may be stored in the historical communication data structure 254 and used to compare to the participants in a current real-time online communication and/or other characteristics of the real-time online communication, to determine which types of participants are present, what type of topics discussed, what time of day the real-time communication is being conducted, and the like, to determine which feedback generation mode is to be utilized, e.g., if the participants are friends/family, the time of day is after work hours, and the topics appear to be more personal in nature and not work-related, then a neutral mode of feedback generation may be selected automatically.

Thus, with the mechanisms of the illustrative embodiments, an automated detection and classification of participant emotional responses to content/information being presented during a real-time online communication is performed and mapped to an emotional response element that may be shared with one or more of the other participants in the real-time online communication. As noted above, this functionality is made possible even when streaming of video/audio content to the other participants in the real-time online communication is disabled by a participant. Thus, the emotional response element may be made perceivable to the other participants even when their video/audio cannot be perceived.

In some illustrative embodiments, the real-time emotional engagement through contextual integration engine 200 may further be configured with the user-specific adaptation and personalization module 260 and the continuous improvement and evaluation module 270. The user specific adaptation and personalization module 260 provides logic for training the real-time feedback generation module 230 using user-specific data to tailor suggestions of emotional response elements to the individual preferences and characteristics of the particular user (participant). This user-specific data may be specific configuration settings input by the user and stored in the user profile 252. This user-specific data may be automatically identified through identification of historical user inputs and selections which may be stored in the historical communication data structure 254. That is, the user-specific adaptation and personalization module 260 may implement reinforcement learning techniques to continually refine the AI computer model(s) 232-234 of the real-time feedback generation module 230 based on user feedback selections and input and interaction patterns detected in the collected data. That is, based on the historical mapping of interaction patterns in the collected data and the user's emotional response elements used in their emotional feedback, these mappings may be used as additional training examples to further train and fine-tune the AI computer model(s) 232-234, e.g., the patterns in the input data may be used as training input with the user's selected emotional response elements being the ground truth label, for example. In this way, the AI computer model(s) 232-234 may be fine-tuned according to the user's own preferences and emotional expression style.

The continuous improvement and evaluation module 270 provides logic for collecting user feedback and engagement metrics to assess the effectiveness of the real-time emotional engagement through contextual integration engine 200. For example, the continuous improvement and evaluation module 270 may employ user surveys, usability tests, and sentiment analysis to evaluate user satisfaction with the engine 200 and identify areas of improvement. The continuous improvement and evaluation module 270 operates to continuously update and refine the AI computer models 232-234 of the real-time feedback generation module 230 based on user feedback, emerging technologies, and advancements in emotional recognition and expression.

Thus, the automated AI computer model based mechanisms of the illustrative embodiments operate to enhance user engagement with real-time online communications by providing mechanisms for automatically determining emotional responses by participants and presenting emotional response elements that inform the other participants of the emotional responses. The illustrative embodiments provide accurate emotional feedback based on the context of the real-time online communication. The illustrative embodiments further provide personalization and adaptation to customize the operation to the particular user (participant) emotional response styles and preferences. The illustrative embodiments can operate to provide emotional response elements even when participant video/audio feeds are not enabled during the real-time online communication.

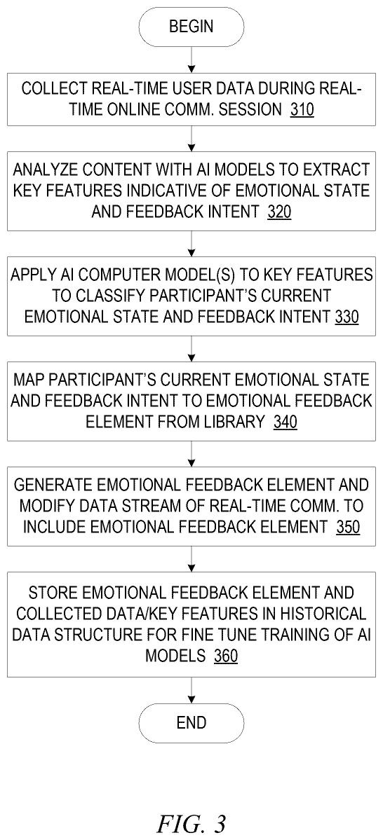

FIG. 3 is a flowchart outlining an example operation of a real-time emotional engagement through context integration engine in accordance with one illustrative embodiment. It should be appreciated that the operations outlined in FIG. 3 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 3, and may, in some cases, make use of the results generated as a consequence of the operations set forth in FIG. 3, the operations in FIG. 3 themselves are specifically performed by the improved computing tool in an automated manner.

The operation outlined in FIG. 3 assumes that the participant has already logged onto the real-time online communication platform and has enabled the automated emotional feedback generation functionality of the illustrative embodiments. Thus, as shown in FIG. 3, the operation starts by collecting real-time user data during the real-time online communication session (step 310). The content of the collected real-time data is analyzed, e.g., through computer vision, natural language processing, audio processing, and the like, to extract key features indicative of emotional state and feedback intent (step 320). One or more AI computer models are applied to the key features to perform sentiment analysis and emotion recognition and thereby interpret and classify the participant's current emotional state and feedback intent (step 330). The participant's current emotional state and feedback intent are mapped to an appropriate emotional feedback element in a library of predefined emotional feedback elements (step 340). The mapping provides an automatically generated emotional feedback element that is then used to modify the participant's data stream of the real-time online communication to include the emotional feedback element (step 350). The emotional feedback element and the collected data and key features are stored in a historical communication data structure for fine-tuned training of the AI computer models (step 360). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
collecting real-time online communication data of a participant computing device of a real-time online communication between a plurality of participant computing devices via one or more data networks;
executing one or more first artificial intelligence (AI) computer models on the collected real-time online communication data to extract key features indicative of an emotional state of a participant associated with the participant computing device;
executing one or more second AI computer models to classify the extracted key features into an emotional feedback classification of a plurality of predefined emotional feedback classifications;
mapping the emotional feedback classification to an emotional feedback element corresponding to the emotional feedback classification, from a plurality of possible emotional feedback elements in a library; and
modifying a data stream, of the real-time online communication, associated with the participant computing device to include the emotional feedback element.

2. The method of claim 1, wherein the one or more first AI computer models comprise at least one of a computer vision AI computer model that analyzes image data of images of the participant captured during the real-time online communication, a computer audio AI computer model that analyzes audio data of vocal input from the participant during the real-time online communication, or a computer natural language processing (NLP) AI computer model that extracts textual features from text corresponding to the real-time online communication.

3. The method of claim 1, wherein executing one or more second AI computer models comprises executing a second AI computer model to perform contextual analysis of previously occurring content of the real-time online communication to determine contextually relevant features for emotional feedback classification.

4. The method of claim 3, wherein the contextual analysis comprises analyzing a real-time online communication topic, a discussion content, and participant profiles to determine a relevance of meeting topics and discussion content to a participant profile of the participant, wherein the emotional feedback classification is determined based on a correlation of the real-time online topic and discussion content with a participant profile of the participant.

5. The method of claim 1, wherein executing one or more second AI computer models comprises executing a second AI computer model to classify a tone and intent of a conversation of the real-time online communication into one of a plurality of different tone and intent categories, wherein the emotional feedback classification is determined based on the classification of the tone and intent.

6. The method of claim 1, wherein executing one or more second AI computer models to classify the extracted key features into an emotional feedback classification further comprises classifying the extracted key features based on a user feedback mode selection specifying a level of sensitivity of the emotional feedback classification of the one or more second AI computer models, wherein the user feedback mode selection is set by the participant to specify how sensitive the participant wants their emotion to be detected and classified during the real-time online communication.

7. The method of claim 1, wherein the emotional feedback element is a graphical animation that is to be output on at least one other participant computing system involved in the real-time online communication.

8. The method of claim 1, further comprising adapting the emotional feedback element based on one or more emotional expression styles of the participant as specified in a user profile.

9. The method of claim 1, wherein at least one other participant computing device generates one of a visual or audible output corresponding to the emotional feedback element and represents the emotional state of the participant.

10. The method of claim 1, wherein the real-time online communication is one of a web conference or a voice-over-internet-protocol (VOIP) communication.

11. A computer program product comprising:
one or more computer-readable storage media; and
program instructions stored on the one or more computer-readable storage media to perform operations comprising:
collecting real-time online communication data of a participant computing device of a real-time online communication between a plurality of participant computing devices via one or more data networks;
executing one or more first artificial intelligence (AI) computer models on the collected real-time online communication data to extract key features indicative of an emotional state of a participant associated with the participant computing device;
executing one or more second AI computer models to classify the extracted key features into an emotional feedback classification of a plurality of predefined emotional feedback classifications;
mapping the emotional feedback classification to an emotional feedback element corresponding to the emotional feedback classification, from a plurality of possible emotional feedback elements in a library; and
modifying a data stream, of the real-time online communication, associated with the participant computing device to include the emotional feedback element.

12. The computer program product of claim 11, wherein the one or more first AI computer models comprise at least one of a computer vision AI computer model that analyzes image data of images of the participant captured during the real-time online communication, a computer audio AI computer model that analyzes audio data of vocal input from the participant during the real-time online communication, or a computer natural language processing (NLP) AI computer model that extracts textual features from text corresponding to the real-time online communication.

13. The computer program product of claim 11, wherein executing one or more second AI computer models comprises executing a second AI computer model to perform contextual analysis of previously occurring content of the real-time online communication to determine contextually relevant features for emotional feedback classification.

14. The computer program product of claim 13, wherein the contextual analysis comprises analyzing a real-time online communication topic, a discussion content, and participant profiles to determine a relevance of meeting topics and discussion content to a participant profile of the participant, wherein the emotional feedback classification is determined based on a correlation of the real-time online topic and discussion content with a participant profile of the participant.

15. The computer program product of claim 11, wherein executing one or more second AI computer models comprises executing a second AI computer model to classify a tone and intent of a conversation of the real-time online communication into one of a plurality of different tone and intent categories, wherein the emotional feedback classification is determined based on the classification of the tone and intent.

16. The computer program product of claim 11, wherein executing one or more second AI computer models to classify the extracted key features into an emotional feedback classification further comprises classifying the extracted key features based on a user feedback mode selection specifying a level of sensitivity of the emotional feedback classification of the one or more second AI computer models, wherein the user feedback mode selection is set by the participant to specify how sensitive the participant wants their emotion to be detected and classified during the real-time online communication.

17. The computer program product of claim 11, wherein the emotional feedback element is a graphical animation that is to be output on at least one other participant computing system involved in the real-time online communication.

18. The computer program product of claim 11, further comprising adapting the emotional feedback element based on one or more emotional expression styles of the participant as specified in a user profile.

19. The computer program product of claim 11, wherein at least one other participant computing device generates one of a visual or audible output corresponding to the emotional feedback element and represents the emotional state of the participant.

20. A computer system comprising:
a processor set;
one or more computer-readable storage media; and
program instructions stored on the one or more computer-readable storage media to cause the processor set to perform operations comprising:
collecting real-time online communication data of a participant computing device of a real-time online communication between a plurality of participant computing devices via one or more data networks;
executing one or more first artificial intelligence (AI) computer models on the collected real-time online communication data to extract key features indicative of an emotional state of a participant associated with the participant computing device;
executing one or more second AI computer models to classify the extracted key features into an emotional feedback classification of a plurality of predefined emotional feedback classifications;
mapping the emotional feedback classification to an emotional feedback element corresponding to the emotional feedback classification, from a plurality of possible emotional feedback elements in a library; and
modifying a data stream, of the real-time online communication, associated with the participant computing device to include the emotional feedback element.
